(19) United States
(12) Patent Application Publication
(10) Pub. No.: US 2006/0004570 A1
(43) Pub. Date: Jan. 5, 2006

(54) Transcribing speech data with dialog context and/or recognition alternative information

(75) Inventors: Yun-Cheng Ju, Bellevue, WA (US); Kuansan Wang, Bellevue, WA (US); Siddharth Bhatia, Kirkland, WA (US)

Correspondence Address: MICROSOFT CORPORATION C/O WESTMAN;CHAMPLIN & KELLY, P.A., SUITE 1400 - INTERNATIONAL CENTRE, 900 SECOND AVENUE SOUTH, MINNEAPOLIS, MN, 55402-3319, US

(73) Assignee: Microsoft Corporation, Redmond, WA (US)

(21) Appl. No.: 10/880,683

(22) Filed: Jun. 30, 2004

(51) Int. Cl. G10L 15/06

(52) U.S. Cl. 704/243

(57) ABSTRACT

A framework for easy and accurate transcription of speech data is provided. Utterances related to a single task are grouped together and processed using combinations of associated sets of recognition results and/or context information in a manner that allows the same transcription for a selected recognition result to be assigned to each of the utterances under consideration.

### BACKGROUND OF THE INVENTION

The present invention relates to speech recognition. More particularly, the present invention relates to transcribing speech data used in the development of such systems.

Speech recognition systems are increasingly being used by companies and organizations to reduce cost, improve customer service and/or automate tasks completely or in part. For example, speech recognition systems can be employed to handle telephone calls by prompting the caller to provide a person's name or department, receive a spoken utterance, perform recognition, compare the recognized results with an internal database, and to transfer the call.

Generally, a speech recognition system uses various modules, such as an acoustic model and a language model as is well known in the art, to process the input utterance. Both general purpose models, or application specific models can be used, if, for instance, the application is well-defined. In many cases though, tuning of the speech recognition system, and more particularly, adjustment of the models is necessary to ensure that the speech recognition system functions effectively for the user group that it is intended. Once the system is deployed, it may be very helpful to capture, transcribe and analyze real spoken utterances in order that the speech recognition system can be tuned for optimal performance. For instance, language model tuning can increase the coverage of the system, while removing unnecessary words so as to improve system response and accuracy. Likewise, acoustic model tuning focuses on conducting experiments to determine improvement in search, confidence and acoustic parameters to increase accuracy and/or speed of the speech recognition system.

As indicated above, transcription of recorded speech data collected from the field provides a means for evaluating system performance and to train data modules. Literally, current practices require a data transcriber/operator to listen to utterances and then type or otherwise associate a transcription of the utterance for each utterance. For instance, in a call transfer system, the utterances can be names of individuals or departments the caller is trying to reach. The transcriber would listen to each utterance and transcribe each request, possibly by accessing a list of known names. Transcription is time consuming and thus, an expensive process. In addition, transcription is also error-prone, particularly for utterances comprising less common names or names with foreign origins. Nevertheless, transcription data is very helpful for speech recognition development and deployment.

There is thus an on-going need for improvements in transcribing speech data. A method or system that addresses one, some or all of the foregoing shortcomings would be particularly useful.

### SUMMARY OF THE INVENTION

Methods and modules for easy and accurate transcription of speech data are provided. Utterances related to a single task are grouped together and processed using combinations of associated sets of recognition results and/or context information in a manner that allows the same transcription for a selected recognition result to be assigned to each of the utterances under consideration. In this manner, the process of speech data transcription is converted into an accurate and easy data verification solution.

In further embodiments, selection of the single recognition result includes removing from consideration at least one of the recognition results based on the context information. For example, this can include removing from consideration those recognition results that have been proffered to the user, but rejected as being incorrect. Likewise, if the user confirms that a recognition result is correct in the context information, the corresponding recognition result can be assigned to all other similar utterances

In yet a further embodiment, measures of confidence can be assigned or associated explicitly or implicitly with the single selected recognition result based on the context information and/or based on the presence of the single selected recognition result in the set of recognition results. The measure of confidence allows for a qualitative or quantitative indication as to whether the transcription provided for the utterance is correct. For instance, the measure of confidence allows the user of transcription data to evaluate performance of a speech recognition system under consideration or tune the data modules based on only transcription data having a selected level of confidence or greater.

### BRIEF DESCRIPTION OF THE DRAWINGS

FIG. 1 is a block diagram of a general computing environment in which the present invention may be practiced.

FIG. 2 is a block diagram of a system for processing speech data.

FIG. 3 is a flow diagram for a first method of processing speech data.

FIG. 4 is a flow diagram for a second method of processing speech data.

FIG. 5 is a flow diagram for a third method of processing speech data.

### DETAILED DESCRIPTION OF ILLUSTRATIVE EMBODIMENTS

The present invention relates to a system and method for transcribing speech data. However, prior to discussing the present invention in greater detail, one illustrative environment in which the present invention can be used will be discussed first.

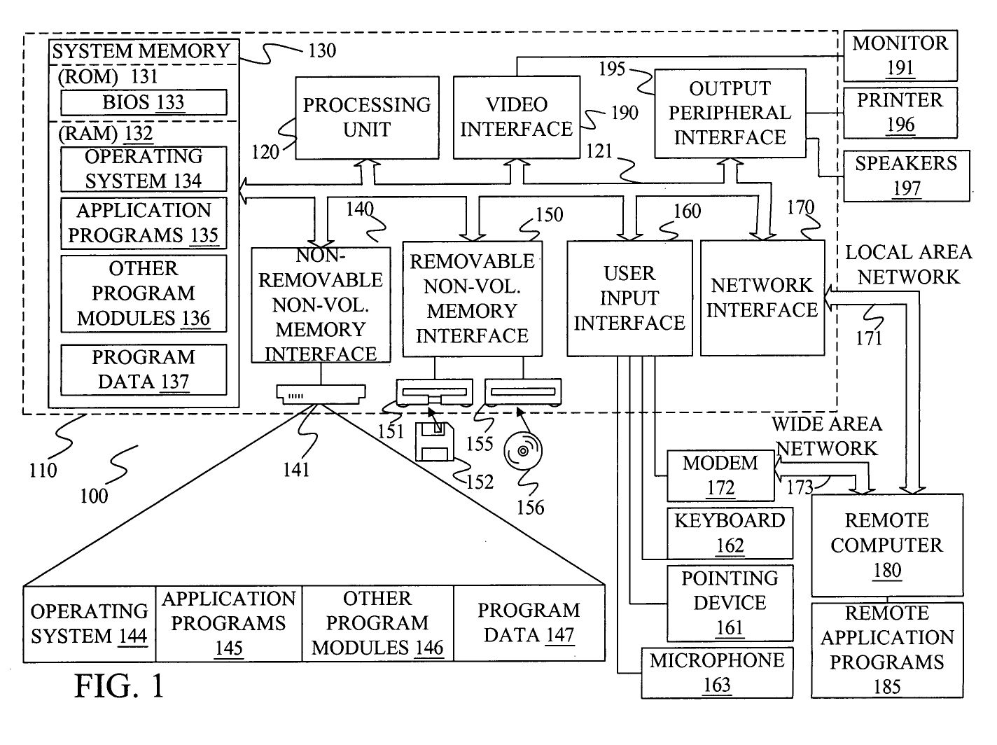

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. Those skilled in the art can implement the description and/or figures herein as computer-executable instructions, which can be embodied on any form of computer readable media discussed below.

The invention may also be practiced in distributed computing environments where tasks are performed by remote processing devices that are linked through a communications network. In a distributed computing environment, program modules may be located in both locale and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a locale bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) locale bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 100. Communication media typically embodies computer readable instructions, data structures, program modules or other data in a modulated data signal such as a carrier WAV or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, FR, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way ◯ example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a locale area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user-input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

It should be noted that the present invention can be carried out on a computer system such as that described with respect to FIG. 1. However, the present invention can be carried out on a server, a computer devoted to message handling, or on a distributed system in which different portions of the present invention are carried out on different parts of the distributed computing system.

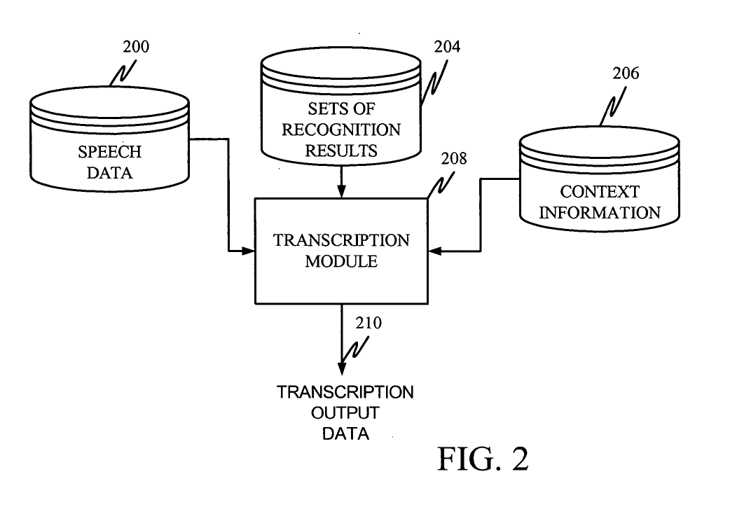

As indicated above, the present invention relates to a system and method for transcribing speech data, which can be used for instance, to further train a speech recognition system or evaluate performance. Resources used to perform transcription include speech data indicated at 200 in FIG. 2, which corresponds to utterances to be transcribed. The speech data 200 can be actual waveform data corresponding to recorded utterances, although it should be understood that speech data 200 can take other forms such as but not limited to acoustic parameters representative of spoken utterances.

A second resource for performing transcription include sets of recognition results 204 from a speech recognition system. In particular, a set of recognition results is provided or associated with each utterance to be transcribed in speech data 200. In general, each set of recognition results is a at least a partial list of possible or alternative transcriptions of the corresponding utterance. Commonly, such information is referred to as an “N-Best” list that is generated by the speech recognition system based on stored data models such as an acoustic model and a language model. The N-Best list entries can have associated confidence scores used by the speech recognition system in order to assess relative strengths of the recognition results in each set, where the speech recognition system generally chooses the recognition result with the highest confidence score. In FIG. 2, the sets of recognition results are illustrated separately from the speech data 200 for purposes of understanding. Each set of recognition results is closely associated with the corresponding utterance, for example, even stored together therewith. It should also be noted that these sets of recognition results 204 can also be generated when desired by simply providing the utterance or speech data to a speech recognition system (preferably of the same form from which the speech data 200 was obtained), and obtaining therefrom a corresponding set of recognition results. In this manner, the number of recognition results for a given utterance in each set can be expanded or reduced as necessary during the transcription procedure described more fully below.

A third resource that can be accessed and used for transcription is information related to the context for at least one, and preferable, a set of utterances related to performing a single task. The context information is illustrated at 206 in FIG. 2. For instance, a set of utterances in speech data 202 can be for a single caller in a speech recognition call transfer application who has had to provide the desired recipient's name a number of times. For example, suppose the following dialog occurred between the speech recognition system and the caller:

System: “Who would you like to reach?”

Caller: “Paul Toman”

System: “Did you say Paul Coleman?”

Caller: “No, Paul-Toman”

System: “Did you say Paul Toman?”

Caller: “Yes”

In this example, the caller provided “Paul Toman” twice, in addition to a correction “No” as well as confirmation “Yes”. Depending on the dialog between the speech recognition system and the caller, context information 206 can include similar utterances related to performing a single desired task, and/or correction information and/or confirmation information as illustrated above. In addition, the context information can take other forms such as spelling portions or complete words in order to perform the task, and/or providing other information such as e-mail aliases in order to perform the desired task. Likewise, context information can take other forms besides spoken utterances such as data input from a keyboard or other input device as well as DTMF tones generated from a phone system as but just another example.

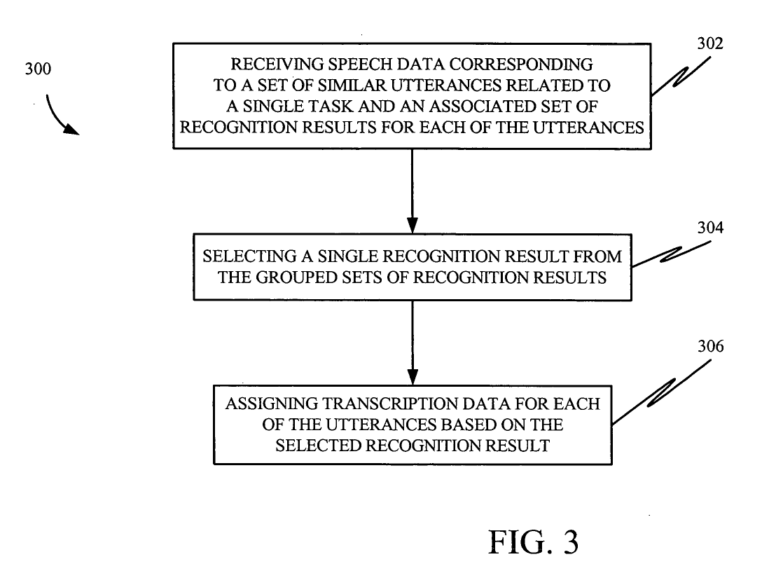

Speech data 200, sets of recognition results 204 and/or context information 206 are provided to a transcription module 208 that can process combinations of the foregoing information and provide transcription output data 210 according to aspects of the present invention. FIG. 3 illustrates a first method 300 for processing just the speech data 202 and corresponding sets of recognition results 204 in order to provide transcription output data 210. Method 300 includes step 302 comprising receiving or identifying as a group speech data corresponding to a set of similar utterances related to a single task as well as an associated set of recognition results for each of the utterances. At step 304, having grouped the sets of similar utterances and the corresponding recognition results based on the single task, a single recognition result is selected from the grouped (whether in fact combined or not) sets of recognition results. Transcription data is then assigned at step 306 for each of the similar utterances based on the selected recognition result. In the context of the example provided above, there are two utterances for “Paul Toman” provided by the caller, each of these utterances would be assigned transcription data, commonly textual data or character sequences, indicative of “Paul Toman”.

The method of FIG. 3 illustrates how speech data 200 and the sets of the recognition results 202 can be processed in order to provide transcription data for similar utterances. In one embodiment, the transcription module 208 can render the utterances to a transcriber, possibly in combination with rendering the sets of recognition results provided by the speech recognition system so that the transcriber can select the correct transcription for multiple occurrences of the same utterance, thereby quickly assigning transcription information to a set of similar utterances without individually having to select the transcription data separately for each utterance. In this manner, the transcriber can process the speech data quicker, thereby significantly saving time and improving efficiency.

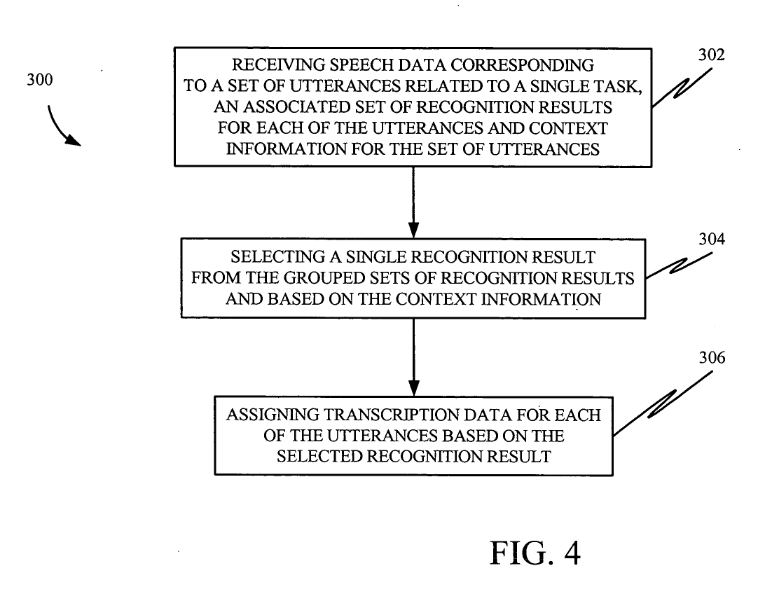

In a further embodiment, step 302 can include receiving context information 206 of the utterances for the task, while the step of selecting the single recognition result is further based on the context information 206. This is illustrated in FIG. 4. As indicated above, context information can take many different forms. Probably, the most definitive form, as illustrated above in the foregoing example, is when the caller informs the system a selected recognized result is correct. Thus, in response to the second utterance of the caller, the speech recognition system provided a set of recognition results (e.g. N-Best list) that presumably ranked “Paul Toman” as the best possibility for the utterance. Using the confirmed recognition result from the context information, the transcription module 208 can select this transcription and assign it to both of the utterances. It should be noted that little or any transcriber/operator interaction is necessary under this scenario since the transcription module 208 can assume that the selected recognition result is correct due to the confirmation in the dialogue between the system and the caller.

Even if the confirmation was not present as in the example provided above, additional context information can be used to efficiently select a single recognition result for the set of utterances. In one embodiment, this can include rendering each of the recognition results for each of the utterances to the transcriber/operator with the additional information learned from the context information. In the example above, the speech recognition system incorrectly selected “Paul Coleman” in response to the first utterance since the caller indicated that this name was incorrect by stating “No, Paul Toman.” The transcription module 208 can use this additional information (the fact that the selected recognition result was wrong) to modify the sets of recognition results in order to convey to the transcriber/operator that “Paul Coleman” was incorrect. For instance, the transcription module 208 could simply remove “Paul Coleman” from each of the sets of recognition results, or otherwise indicate that this name is incorrect. Thus, assuming that the affirmative confirmation “Yes” was not present in the above dialogue and only the two utterance providing the persons name were present (for instance, if the caller gave up after providing the person's name the second time), the transcriber/operator may easily select “Paul Toman” as the correct recognition result since this recognition result remains relatively high in each of the sets of recognition results. In further embodiments, the transcription module 208 could combine the sets of recognition results, based on, for example, confidence scores, in order to provide a single list based on all of the utterances. Again, this may allow the transcriber/operator to easily select the correct recognition result that will be assigned to all of the utterances spoken for the single task under consideration.

The manner in which recognition results are rendered to the transciber/operator can take numerous forms. For example, rendering can comprise rendering the recognition results for different utterances at the same time and before the step of selecting. While, in yet a different embodiment, rendering can comprise rendering the recognition results for different utterances successively in time with the rendering of the corresponding utterance.

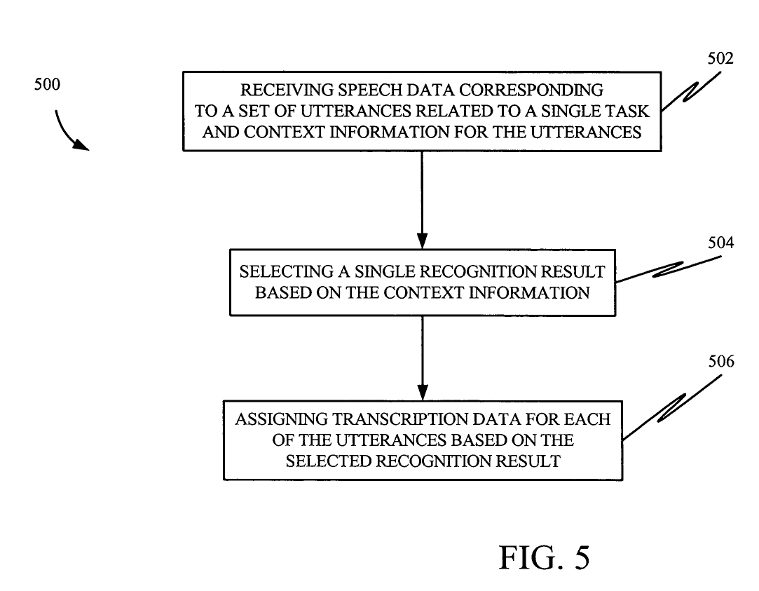

FIG. 5 illustrates another method for processing speech data, which is operable by the transcription module 208. As with the methods described above, method 500 includes receiving speech data 200 corresponding to a set of utterances related to a single task and context information 206 of the utterances for the single task at step 502. At step 504, the transcription module selects a single recognition result based on the context information 206. At step 506, the transcription module 208 assigns transcription data for each utterances based on the selected recognition result. In the dialogue scenario provided above, the transcription module 208 can easily ascertain the correct transcription for each of the utterance is “Paul Toman” due to the presence of the confirmation “Yes.” In this example, a set of recognition results for each of the utterances for the person's name is not really necessary because the confirmation is present in the dialogue. Thus, if the transcription module has the transcription for “Paul Toman”, for instance, from the set of recognition results for the second utterance, the transcription module 208 can assign the transcription “Paul Toman” to both of the utterances. As indicated above, context information can take other forms such as but not limited to context information having confirmations. Other examples, include dialog indicating a selection by the speech recognition system was wrong, partial or complete spellings of words, and/or additional information such as e-mail aliases, etc.

In addition to providing transcription data for each utterance based on the selected recognition result, a measure of confidence pertaining to whether the transcription provided for the utterance is correct can also be optionally provided. In the methods illustrated in FIGS. 3-5, the measure of confidence for each utterance can be included in steps 306 and 506. The measure of confidence allows the user of the transcription output data 208 to evaluate performance of the speech recognition system under consideration or tune the data modules based on, for example, only transcription data 208 having a selected level of confidence or greater. In one embodiment, a measure of confidence can be ascertained quantitatively from the sets of recognition results and/or context information 206 related to each of the sets of utterances. For example, if the user has confirmed a recognition result in the dialogue, such as illustrated above, the transcription module can assign a “high” confidence measure to the transcription output data 208 for these utterances.

In another dialogue exchange, suppose the user did not confirm the recognition result from the speech recognition system for one of the utterances, but the selected recognition result and provided in transcription output 208 occurred in each of the sets of recognition results for the utterances under consideration. In other words, the selected recognition result occurred in each of the N-Best lists for each of the utterances. In this scenario, the transcription module 208 can assign a “medium-high” confidence level to the resulting transcription output data 208.

In another dialogue exchange of utterances, suppose the transcriber/operator has chosen a recognition result that only appeared in one of the sets of recognition results, then transcription module 208 could assign a “medium-low” confidence level for the transcription output data.

Finally, suppose the transcriber/operator provided a recognition result that was not present in any of the sets of recognition results, or was a recognition result that was not ranked high in any of sets of recognition results, than the transcription module 208 could assign a confidence level of “low” to the corresponding transcription output data.

The foregoing are but some examples of criteria for assigning confidence measures to transcription output data. In general, the criteria can be based on the context information 206 and/or based on the set of recognition results such whether or not the selected recognition result appeared in one or all of the sets of recognition results, or its ranking in each of the sets of recognition results. Assignment of the confidence measure to the transcription data can be done explicitly or implicitly. In particular, each transcription in the transcription output data 208 could include an associated tag or other information indicating the corresponding confidence measure. In a further embodiment, explicit confidence levels may not be present in the transcription output data 208, but rather, be implicit by merely forming the transcript output data into groups, where all the “high” confidence level transcription output data is grouped together, and all of the other levels of confidence measure for the transcription output data are likewise grouped together. In this manner, the user of the transcription output data 208 can simply use which ever collection of transcription output data 208 he/she desires.

In summary, the present invention provides a framework for easy and accurate transcription of speech data. Utterances related to a single task are grouped together and processed using combinations of associated sets of recognition results and/or context information in a manner that allows the same transcription for a selected recognition result to be assigned to each of the utterances under consideration. Aspects of the invention disclosed herein have converted the process of data transcribing into an accurate and easy data verification solution.

Although the present invention has been described with reference to particular embodiments, workers skilled in the art will recognize that changes may be made in form and detail without departing from the spirit and scope of the invention.

What is claimed is:

1. A method for processing speech data comprising:
receiving speech data corresponding to a set of similar utterances related to a single task and an associated set of recognition results for each of the utterances;
selecting a single recognition result from the set of recognition results; and
assigning transcription data for each utterance based on the selected recognition result.

2. The method of claim 1 and further comprising:
receiving further information related to context of the utterances for the single task, and wherein selecting the single recognition result is based on said further information.

3. The method of claim 1 wherein receiving the associated set of recognition results for each of the utterances comprises processing the speech data for the set of similar utterances after receipt thereof.

4. The method of claim 1 wherein receiving the associated set of recognition results for each of the utterances comprises receiving the associated set of recognition results with the speech data corresponding to the recognition results.

5. The method of claim 1 and further comprising:
rendering recognition results for different utterances of the set of the utterances in proximity to each other.

6. The method of claim 5 wherein rendering comprises rendering the recognition results for different utterances of the set of utterances at the same time and before the step of selecting.

7. The method of claim 5 wherein rendering comprises rendering the recognition results for different utterances of the set of utterances successively in time and before the step of selecting.

8. The method of claim 2 wherein selecting the single recognition result comprises removing from consideration at least one of the recognition results based on the further information.

9. The method of claim 2 wherein selecting the single recognition result comprises selecting the single recognition result based on the further information.

10. The method of claim 2 and further comprising:
assigning a measure associated with the single selected recognition result based on the further information.

11. The method of claim 1 and further comprising:
assigning a measure associated with the single selected recognition result based on the presence of the single selected recognition result in the set of recognition results.

12. A method for processing speech data comprising:
receiving speech data corresponding to a set of utterances related to a single task and further information related to context of the utterances for the single task;
selecting a single recognition result based on the further information related to context of the utterances; and
assigning transcription data for each utterance based on the single recognition result.

13. The method of claim 12 wherein receiving includes receiving an associated set of recognition results for at least one of the utterances and selecting comprises selecting the single recognition result from the associated set of recognition results.

14. The method of claim 13 wherein selecting the single recognition result comprises removing from consideration at least one of the recognition results based on the further information.

15. The method of claim 13 wherein selecting the single recognition result comprises selecting the single recognition result based on the further information.

16. The method of claim 13 and further comprising:
assigning a measure associated with the single selected recognition result based on the further information.

17. The method of claim 13 wherein receiving speech data corresponding to a set of utterances includes receiving an associated set of recognition results for each of the utterances.

18. The method of claim 17 and further comprising:
assigning a measure associated with the single selected recognition result based on the presence of the single selected recognition result in the set of recognition results.

19. A computer-readable medium having computer-executable instructions for processing speech data, the computer-readable medium comprising:
a transcription module adapted to receive speech data corresponding to a set of similar utterances related to a single task and at least one of an associated set of recognition results for each of the utterances and further information related to context of the utterances for the single task, and wherein the transcription module is adapted to select a single recognition result based at least one of the sets of recognition results and said further information, the transcription module adapted to assign transcription data for each utterance based on the selected recognition result.

20. The computer readable medium of claim 19 wherein the transcription module is adapted to select the single recognition result by removing from consideration at least one of the recognition results based on the further information.

21. The computer readable medium of claim 19 wherein the transcription module is adapted to assign a measure associated with the single selected recognition result based on the further information.

22. The computer readable medium of claim 19 wherein the transcription module is adapted to assign a measure associated with the single selected recognition result based on the presence of the single selected recognition result in the set of recognition results.
